(19) United States
(12) Patent Application Publication
(10) Pub. No.: US 2003/0108110 A1
(43) Pub. Date: Jun. 12, 2003

(54) Systems and methods for reducing electromagnetic emissions in communications

(75) Inventor: Daniel N. Harres, Belleville, IL (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company, Seattle, WA

(21) Appl. No.: 10/016,510

(22) Filed: Dec. 10, 2001

(51) Int. Cl. H04L 27/00

(52) U.S. Cl. 375/259

(57) ABSTRACT

A digital communications system includes a transmitter and a receiver. The transmitter can integrate encoded digital signals by converting the encoded digital signals into integrated signals that are proportional to the time integral of the encoded digital signals. The transmitter can then transmit the integrated signals. The receiver can receive the integrated signals and thereafter differentiate the integrated signals into a representation of the encoded digital signals that is proportional to the rate of change of the integrated signals. By integrating the encoded digital signals at the receiver and thereafter differentiate the integrated signals at the receiver, the system can reduce electromagnetic emissions associated with the transmission of communications via a transmission medium.

### FIELD OF THE INVENTION

The present invention relates generally to systems and methods for transmitting signals and, more particularly, to systems and methods for reducing electromagnetic emissions from transmitted signals.

### BACKGROUND OF THE INVENTION

High speed data transmission and communications are conventionally accomplished by transmitting communications carrier signals, such as optical or radio frequency (“RF”) signals, from one device, such as an optical or RF transmitter or one or more intermediate relay stations, to another device, such as a signal detector, e.g., an optical or RF detector, at the front end of a communications receiver. The communications carrier signals are typically formatted according to a predetermined communications standard which assigns the signal characteristics which define a logic “0” and a logic “1.” One well known standard is the “Manchester” coding technique which assigns a logic “1” to a negative going signal transition and a logic “0” to a positive going signal transition.

Referring to FIG. 1, one typical configuration for a digital communications system 10 includes a transmitter 12 and a receiver 14 electrically connected via a transmission medium 16. The transmitter includes an encoder 18, which is configured according to the predetermined communications standard, so as to encode data according to the predetermined communications standard. To drive the encoded data from the transmitter onto the transmission medium, the transmitter includes a digital driver 20. The digital driver is connected to the transmission medium such that signals can be transmitted from the transmitter to the receiver through the transmission medium. If the transmitter is included within a network, the transmitter can additionally include a network interface 22 connected between a network device and the encoder of the transmitter such that the network device can communicate via the transmission medium. In this configuration, the transmission medium can comprise a network bus.

The receiver 14 includes a digital receiver 24 and a decoder 26. The receiver receives the encoded data from the transmission medium. And the decoder, which is configured according to the predetermined communications standard, decodes the encoded data received from the transmitter to retrieve a representation of the data. In the same regard as the transmitter, in configurations where the receiver is included within a network the receiver can include a network interface 28 connected between a network device and the decoder of the receiver.

With the transmission of communications many communications systems suffer from a level of electromagnetic emissions. In this regard, everything else being equal, the lower the emissions of the communications in a communication system, the lower the probability that the communication system will interfere with other electronic functions of the system employing the communications system. Generally, however, transmission mediums tend to exhibit characteristics of antennas as the frequency of the carrier signals increase and, as such, electromagnetic emissions tend to increase. And whereas communications systems in complex systems such as automotive and aircraft systems have stringent standards for the quality of transmissions, the standards for the quality of transmissions become even more stringent as the carrier frequency increases, particularly over 30 MHz. Whereas a communications standard with high emissions can be used in a number of applications, implementation of the standard may require a more costly transmission medium or may require that the communications data rate be lowered.

As stated, the “Manchester” coding technique assigns a logic “1” to a negative going signal transition and a logic “0” to a positive going signal transition. In this regard, Manchester encoded signals are square-wave signals that are quite simple to generate at the transmitter and require no complex matched filter at the receiver. However, the frequency spectrum of a Manchester encoded signal typically exhibits significant electromagnetic emissions at frequencies out to many times the carrier frequency, seen as undesirable large sidelobes in the frequency spectrum,. For example, a 10 Mb/sec Manchester encoded data stream will exhibit significant electromagnetic emissions out to many times 10 MHz.

A number of modem communications standards contain energy to frequencies below the carrier frequency. And in fact, some communications standards can contain the energy to frequencies of only a small fraction of the carrier frequency. For example, modem modems that communicate over conventional telephone lines can transmit communications at a 50 Kb/sec data rate using less than 4 KHz of energy. Whereas the sophisticated communications standards containing energy to frequencies below the carrier frequency have many applications, such sophisticated communications standards are generally unpractical for many complex automotive and aircraft communications systems. The use of such sophisticated communications standards at megabit-per-second and higher communication data rates typically requires considerable circuit complexity. And as such, the cost to implement such sophisticated communications standards in complex automotive and aircraft communications systems is generally prohibitive. Additionally, as existing automotive and aircraft communications systems already operate according to specific communications standards, changing to one of the sophisticated communications standards would also cost more than the value that would be returned. Therefore, it would be desirable to design a system that provides a simple, low-cost retrofit to existing complex communications systems to reduce electromagnetic emissions associated with high-speed data transmissions.

### SUMMARY OF THE INVENTION

In light of the foregoing background the present invention provides an improved digital communications system including a digital communications transmitter and receiver. The transmitter and receiver of the present invention can be implemented as a low-cost retrofit to existing complex communications systems to transmit and receive digital signals, respectively, having reduced electromagnetic emissions. The transmitter and receiver of the present invention can reduce the electromagnetic emissions without requiring considerable circuit complexity. Additionally, the transmitter and receiver can operate with many conventional encoding techniques already used in complex communications systems such as complex automotive and aircraft communications systems.

According to one aspect of the present invention, a digital communications system includes a digital communications transmitter and a digital communications receiver. The transmitter includes an encoder, an integrator and a transmitter element. The encoder is capable of encoding at least one digital signal according to a predefined communications standard. For example, the encoder can encode the digital signals according to a predefined communications standard that has zero content at a DC voltage level, such as Manchester encoding, 4B5B encoding, 5B6B encoding and 8B10B encoding. The integrator is capable of integrating the encoded digital signals by converting the encoded digital signals into an at least one integrated signal that is proportional to the time integral of the encoded digital signals. The integrator can be an RC integrator comprising a low pass filter having at least one resistor and at least one capacitor. In this regard, the RC integrator approximates the operation of a non-ideal integrator. Following integrating the encoded digital signals, the transmitter element is capable of transmitting the integrated signals.

The receiver includes a receiver element, a differentiator and a decoder. The receiver element is capable of receiving the integrated signals. And from the receiver element, the differentiator is capable of converting the integrated signals into a representation of the encoded digital signals that is proportional to the rate of change of the integrated signals. In this regard, the differentiator can be an RC differentiator comprising a high pass filter having at least one resistor and at least one capacitor. In this regard, the RC differentiator approximates the operation of a non-ideal differentiator. The decoder is capable of decoding the representation of the encoded digital signals according to a predefined communications standard to thereby obtain a representation of the digital signals. For example, the decoder can decode the digital signals according to a predefined communications standard that has zero content at a DC voltage level, such as Manchester encoding, 4B5B encoding, 5B6B encoding and 8B10B encoding.

In another embodiment, the receiver further includes a comparator. The comparator is capable of restoring the encoded digital signals from the representation of the encoded digital signals by comparing the representation of the encoded digital signals to at least one reference digital signal and thereafter setting the representation of the encoded digital signals relative to the reference digital signals. Also, the receiver can further include a coupler capable of AC coupling the representation of the encoded digital signals before the comparator restores the encoded digital signals.

In operation, the transmitter integrates the encoded digital signals by converting the encoded digital signals into the integrated signals that are proportional to the time integral of the encoded digital signals, such as by low pass filtering the encoded digital signals. In another embodiment, the encoder first encodes the digital signals before the integrator integrates the encoded digital signals. The transmitter element then transmits the integrated signals and thereafter the receiver element receives the integrated signals. Next, the differentiator differentiates the integrated signals by converting the integrated signals into a representation of the encoded digital signals that is proportional to the rate of change of the integrated signals, such as by high pass filtering the integrated signals. The decoder can then decode the representation of the encoded digital signals to thereby obtain a representation of the digital signals.

In one embodiment, after differentiating the integrated signals, the comparator restores the encoded digital signals from the representation of the encoded digital signals. Additionally, the coupler of the receiver can AC couple the representation of the encoded digital signals before the comparator restores the encoded digital signals. In this regard, the comparator can restore the encoded digital signals by comparing the representation of the encoded digital signals to the reference digital signals and thereafter set the representation of the encoded digital signals relative to the reference digital signals.

Therefore the transmitter and receiver of the present invention can be implemented as a low-cost retrofit to existing complex communications systems operating according to existing communications standards, such as in complex automotive and aircraft communications systems. The transmitter and receiver can transmit and receive digital signals, respectively, having reduced electromagnetic emissions without requiring considerable circuit complexity.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a conventional digital communications system;

FIG. 2 is a schematic block diagram of a digital communications system according to one embodiment of the present invention;

FIGS. 3A and 3B are schematic circuit diagrams of an ideal integrator and an RC integrator, respectively;

FIG. 4 is a graph comparing the frequency response of an ideal integrator with the frequency response of an RC integrator;

FIG. 5 is a graph comparing the frequency spectrum of non-integrated data signals with the frequency response of integrated data signals according to one embodiment of the present invention;

FIG. 6 is a graph comparing the waveform of Manchester encoded data signals with the waveform of the integral of the Manchester encoded data signals according to one embodiment of the present invention;

FIGS. 7A and 7B are schematic circuit diagrams illustrating an ideal differentiator and an RC differentiator, respectively;

FIG. 8 is a graph comparing the frequency response of an ideal differentiator with the frequency response of an RC differentiator; and

FIG. 9 is a schematic block diagram illustrating an exemplar network system that can utilize the digital communications system of one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

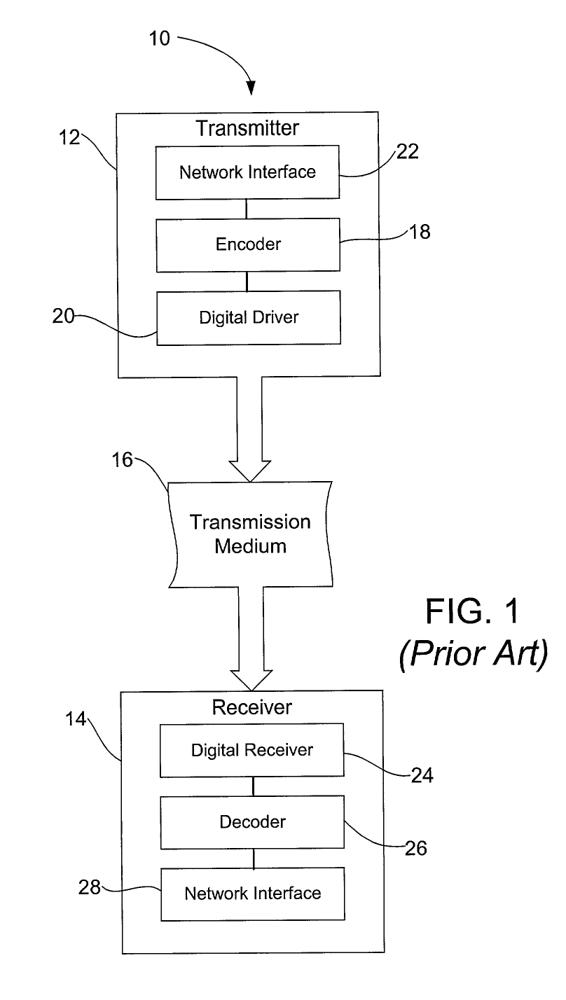

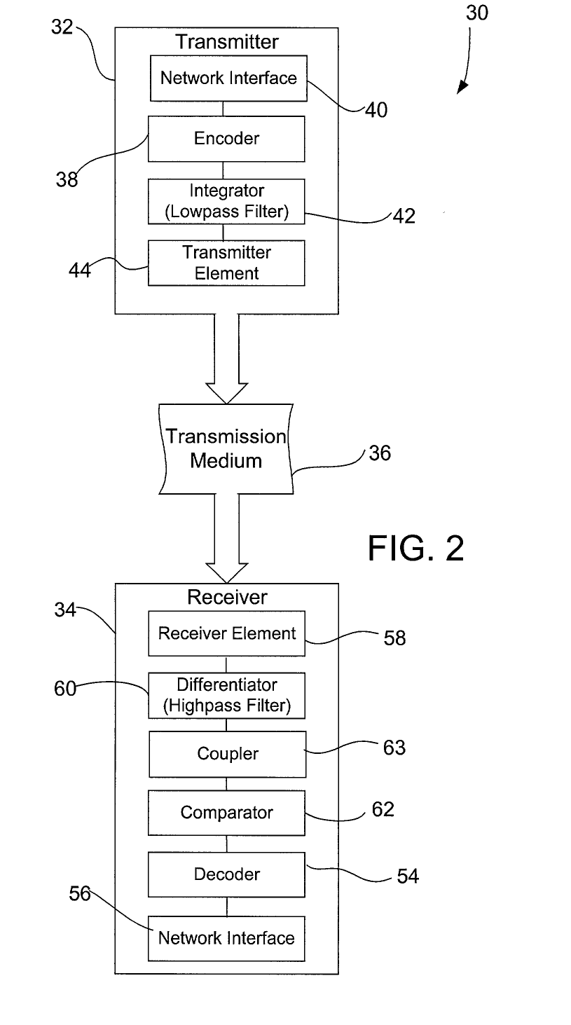

Referring to FIG. 2, one configuration for a digital communications system 30 according to the present invention includes a transmitter 32 and a receiver 34 electrically connected via a transmission medium 36. Like the conventional digital communications system described above with reference to FIG. 1, the transmitter of the digital communications system includes an encoder 38 that is configured according to a predetermined communications standard and encodes data signals according to the predetermined communications standard. The predetermined communications standard can be any of a number of different communications standards that have zero content at DC, including the Manchester coding technique as well as the 4B5B, 5B6B and 8B10B coding techniques. Also like the conventional digital communication system, if the transmitter is included within a network, the transmitter can additionally include a network interface 40 connected between a network device and the encoder of the transmitter such that the network device can communicate via the transmission medium by generating the data signals.

In contrast to the digital driver of the conventional digital communications system, however, the transmitter 32 of the digital communications system 30 of the present invention includes an integrator 42 and a linear transmitter element 44. As known to those skilled in the art, an integrator takes an input signal and outputs an approximation of the input signal that is proportional to the time integral of the input signal. In this regard, the integrator can input the encoded data signals, attenuate at least a portion of the high frequency harmonics that cause the electromagnetic emissions from the system, and output an integration of the encoded data signals.

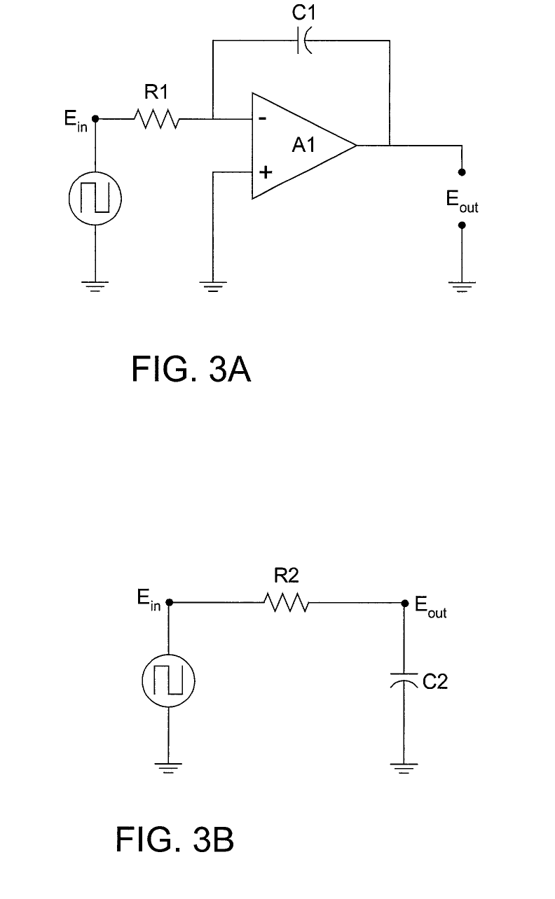

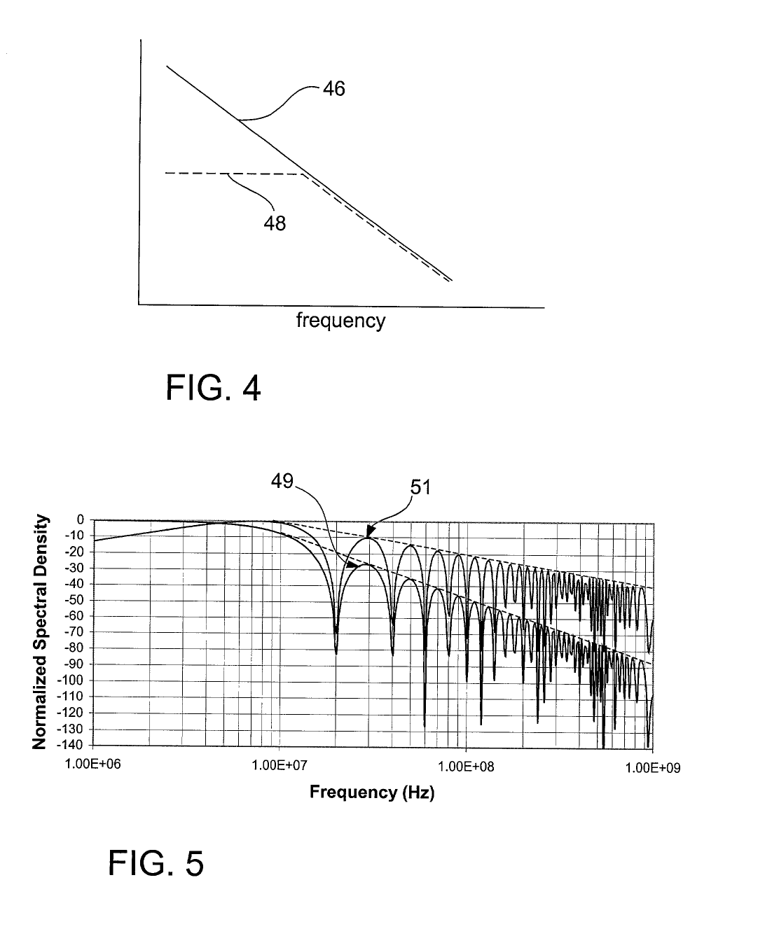

One type of integrator, sometimes referred to as an ideal integrator, shown in FIG. 3A, generally comprises an ideal capacitor C1 and an ideal resistor R1 combined with an operational amplifier A1. If a single pulse Eᵢₙ is applied to the input of an ideal integrator, the pulse will drive the integrator's output signal Eₒᵤₜ to a non-zero value that is proportional to the area of the signal pulse. But due to DC integrator buildup associated with practical integrator implementations, if no other pulses or signals are applied to the integrator, the output signal will undesirably remain indefinitely. Thus, the integrator 42 is preferably a non-ideal integrator approximated as an RC low pass filter. A comparison of the frequency response of an ideal integrator (line 46) and the RC low pass filter approximation (line 48) is shown in FIG. 4.

As shown in FIG. 3B, the RC integrator 42, comprising an RC filter approximation of the ideal integrator, can comprise a first-order low pass filter including resistor R2 in series with capacitor C2. It should be understood, though, that the RC filter approximation can comprise higher-order low pass filters without departing from the spirit and scope of the present invention. The resistor and capacitor can be selected based on the desired output, but in one embodiment the resistor and capacitor are selected such that the pole of the RC integrator is at approximately one-tenth the carrier frequency, or 0.1/T where T is the cycle time of the carrier signal. As shown in FIG. 5, for example, the frequency spectrum of data signals encoded with a 1 MHz carrier signal according to the Manchester encoding technique exhibit a significant reduction in the high frequency sidelobes above the pole frequency when integrated (line 49), as compared to not being integrated (line 51).

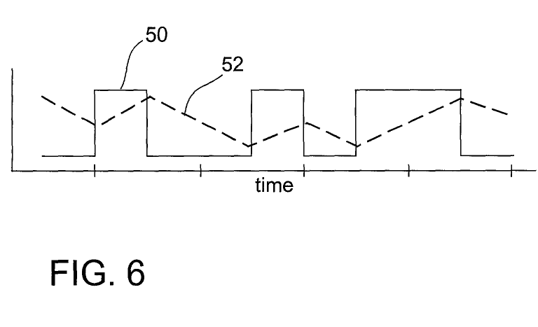

As known, a quick change in input voltage Eᵢₙ caused by a transition of the input signal from a logic “1” to a logic “0,” or visa versa, leaves the capacitor C2 voltage, or output voltage Eₒᵤₜ, unaffected. Therefore, a voltage difference is produced across the resistor R2 and a current flows. The current tends to charge the capacitor toward an output voltage equal to the input voltage. As the input and output voltages begin to equalize, the current falls and the rate of change of the output voltage decreases. In this regard, the output voltage increases exponentially approaching the input voltage. As shown in FIG. 6, when a square-wave data signal (line 50) is applied to the input of the RC integrator 42, the output data signal (line 52) appears as a somewhat triangular wave that linearly increases and decreases along with the current level of the input square-wave data signal.

Referring back to FIG. 2, the transmitter 32 further includes the transmitter element 44 to drive the integrated data signals onto the transmission medium 36. Because the instantaneous signal transitions associated with the square-wave data signals have been integrated and now appear as graduated signal transitions of the triangular-wave data signals, the transmitter element is preferably an analog driver, in contrast to the digital driver of the conventional digital communications system. In addition to driving the integrated data signals onto the transmission medium, if desired, the analog driver can provide gain to the integrated data signals.

After the transmitter element 44 has driven the integrated data signals onto the transmission medium 36, the integrated data signals travel through the transmission medium from the transmitter 32 to the receiver 34. The transmission medium can be any of a number of mediums, including a single-ended transmission line or a differential transmission line which, if the system is employed in a network, can comprise a network bus.

From the transmission medium 36, the receiver 34 can receive the integrated data signals. Similar to conventional digital communications systems, the receiver includes a decoder 54 and a network interface 56 (for embodiments where the receiver is included within a network). But the receiver of the digital communications system of the present invention includes a receiver element 58, a differentiator 60 and a comparator 62, in contrast to the digital receiver of the conventional receiver. The receiver element, such as an analog receiver, receives the integrated data signals from the transmission medium and thereafter passes the integrated data signals to the differentiator, which converts the integrated data signals into a representation of the encoded data signals. The comparator then compares the representation to a reference data signal to characterize each individual pulse of the data signals as either a logic “1” or a logic “0,” to thereby restore the encoded data signals from the representation of the encoded data signals.

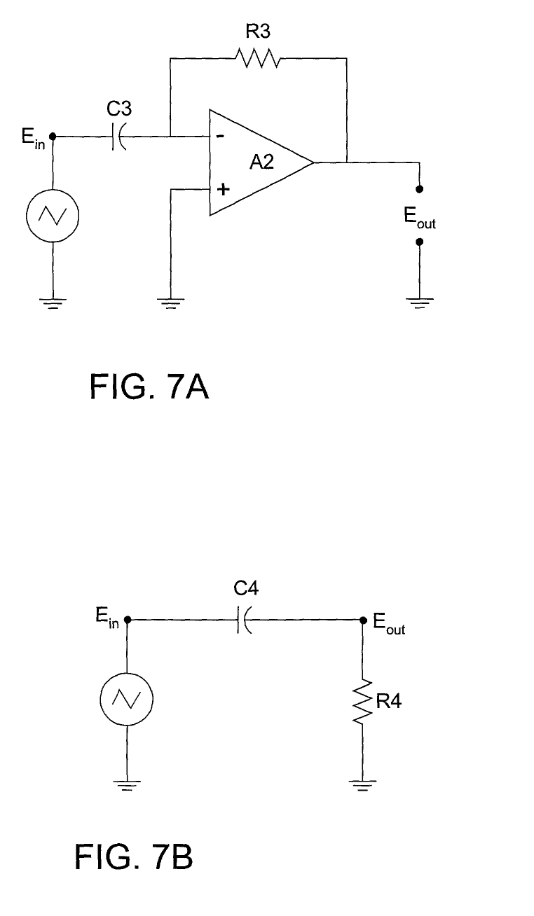

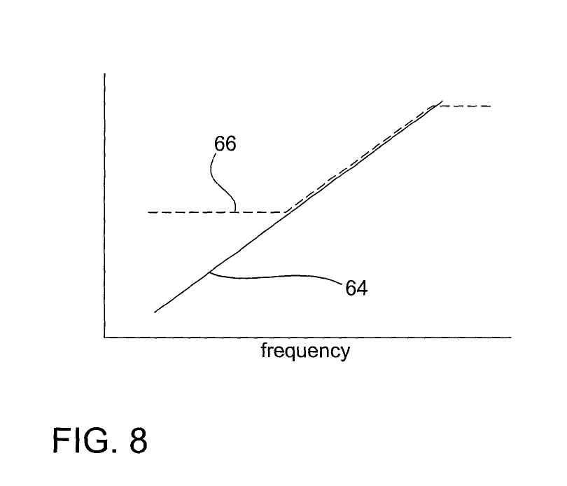

Similar to the ideal integrator, an ideal differentiator generally comprises an ideal capacitor C3 and an ideal resistor R3 combined with an operational amplifier A2. As shown in FIG. 7A, however, the positions of the capacitor and resistor are reversed from those ones of the ideal integrator. If a single pulse Eᵢₙ is applied to the input of an ideal integrator, it will drive the differentiator's output signal Eₒᵤₜ to a non-zero value that is proportional to the rate at which the input pulse is changing. But the ideal differentiator is an inherently unstable circuit that, if used, would provide high gain to high frequency noise within the receiver 34, which could in turn create errors in the conversion of the integrated data signals into the representation of the encoded data signals. Therefore, also like the integrator 42, the differentiator 60 is preferably a non-ideal differentiator. In this regard, the non-ideal differentiator can be approximated in any one of a number of manners to prevent amplification of the receiver's high frequency internal noise but, in one embodiment, the non-ideal differentiator is approximated as an RC high pass filter. A comparison of the frequency response of an ideal differentiator (line 64) and the RC high pass filter approximation (line 66) is shown in FIG. 8.

As shown in FIG. 7B, the RC differentiator can comprise a first-order high pass filter including resistor C4 in series with capacitor R4. It should be understood, though, that the RC filter approximation can comprise higher-order high pass filters without departing from the spirit and scope of the present invention. As illustrated, the capacitor and resistor are reversed from their respective positions in the RC integrator illustrated in FIG. 3B. The capacitor and resistor can be selected based on the desired output but, in one embodiment, the capacitor and resistor are selected such that the RC differentiator has a zero at approximately the same frequency as the pole of the RC integrator (i.e., one-tenth the carrier frequency) and a pole at approximately two times the carrier frequency.

As known, it takes a finite time to change a charge stored in the capacitor C4 and, as a result, a quick change in input voltage Eᵢₙ caused by a transition of the input signal from a logic “1” to a logic “0,” or visa versa, leaves the capacitor voltage unaffected. Therefore, such a transition causes the voltage across the resistor R4, or output voltage Eₒᵤₜ, to experience sudden changes. But any voltage across the resistor produces a current that tends to change the charge of the capacitor and, as such, the voltage across the capacitor slowly changes to absorb the applied voltage from the resistor. In this regard, while a steady input voltage initially appears across the resistor as the output voltage, the output voltage slowly decreases. Therefore, by passing the triangular-wave integrated data signals through the differentiator 60, the integrated data signals are converted into a representation of the encoded data signals. But because the zero of the differentiator cuts off the gain of the differentiator before amplifying the high frequency harmonics, the representation will be a slightly distorted square-waveform, but will have limited noise enhancement.

Due to the distortion caused by the differentiator 60, the receiver 34 includes the comparator 62 to restore the square-wave encoded data signals from the representation of the encoded data signals. As known, comparators input two analog signals and output a binary, square-wave signal, which remains constant as the differential input voltage increases or decreases. To restore the encoded data signals, the comparator inputs the representation of the encoded data signals and a reference data signal, which is set at a threshold level between the minimum and maximum voltage levels of the encoded data signals. When the representation of the encoded data signals is at a level between the threshold and the minimum, the comparator outputs the minimum voltage level of the encoded data signals. And when the representation of the encoded data signals is at a level between the maximum and the threshold, the comparator outputs the maximum voltage level of the encoded data signals.

The threshold of the comparator 62 can be set at any one of a number of different levels between the minimum and maximum voltage levels of the encoded data signals. For example, the threshold can be set halfway between the minimum and maximum voltage levels. In this regard, it should be noted that the representation of the encoded data signals will not introduce significant phase jitter, but the slower edges of the representation can cause small voltage fluctuations that, in turn, can cause the comparator to undesirably output a nearly continuous change in the output when the voltage difference between the representation and the threshold is near zero volts. As such, in a preferred embodiment, the receiver includes a coupler 63 that can AC-couple the representation of the encoded data signals prior to being input into the comparator. In this regard, the threshold of the comparator is preferably set to zero volts. Additionally, a predefined level of hysteresis is preferably integrated into the comparator. And while the hysteresis level can be set to any one of a number of levels, the hysteresis level should be such that the comparator responds quickly to the representation of the encoded data signals.

Once the comparator 62 has restored the encoded data signals from the representation of the encoded data signals, the decoder 54 can decode the encoded data signals into a representation of the original data signals. In this regard, the decoder is configured according to the predetermined communications standard utilized by the encoder. And, as stated previously, the predetermined communications standard can comprise any one of a number of communications standards that have zero content at DC, including the Manchester coding technique as well as the 4B5B, 5B6B and 8B10B coding techniques. Then, from the decoder the data signals can be utilized by a device connected to the receiver 34, such as by a network device in embodiments where the transmitter 32 and receiver are included within a network and each include network interfaces 40, 56.

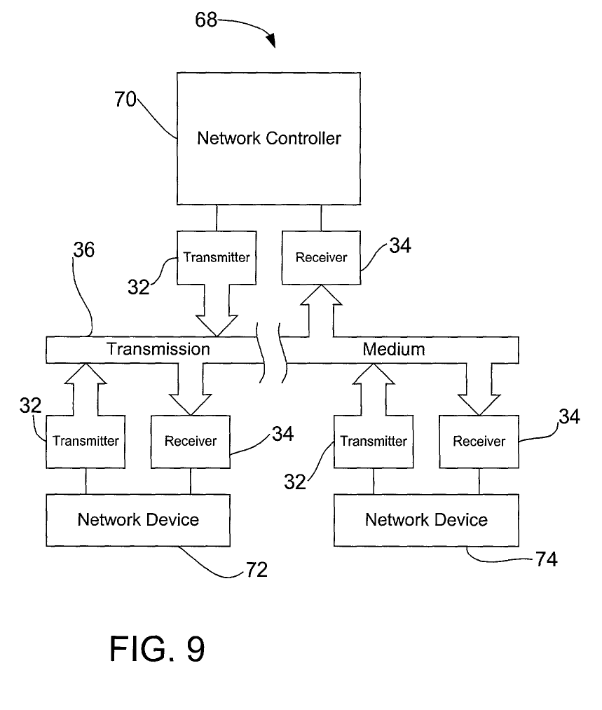

As indicated above, the transmitter 32 and receiver 34 can be included within a network where the transmission medium 36 comprises a network bus. In this regard, one exemplar network is illustrated in FIG. 9 and described in U.S. patent application Ser. No. 09/735,146, entitled: Network Device Interface for Digitally Interfacing Data Channels to a Controller Via a Network filed on Dec. 12, 2000 and U.S. patent application Ser. No. 09/736,878, entitled: Network Controller for Digitally Controlling Remote Devices Via a Common Bus filed on Dec. 14, 2000 both of which are incorporated herein by reference. As shown in FIG. 9, the exemplar network system 68 has a host computer or network controller 70 and a number of network devices 72, 74, in addition to a number of transmitters, receivers and the transmission medium (i.e., network bus). In this configuration, the network controller typically provides configuration and control of the network and, therefore, directs communications with the network devices. In operation, the bus controller typically transmits commands via a respective transmitter and the network bus to the network devices. The network device or devices, in turn, receive the commands via the network bus and respective receivers, and thereafter perform the actions associated with the command.

The transmitter and receiver of the digital communications system therefore provides an improved digital communications system that reduces electromagnetic emissions in high-speed data transmissions. The transmitter and receiver of the present invention, which can be implemented as a low-cost retrofit to existing complex communications systems, can reduce the electromagnetic emissions without requiring considerable circuit complexity. And the transmitter and receiver can operate with many conventional encoding techniques already used in complex communications systems such as complex automotive and aircraft communications systems.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of transmitting and receiving at least one signal comprising:
integrating at least one encoded digital signal, wherein integrating comprises converting the at least one encoded digital signal into an at least one integrated signal that is proportional to the time integral of the at least one encoded digital signal;
transmitting the at least one integrated signal; and
receiving the at least one integrated signal following transmission and thereafter differentiating the at least one integrated signal, wherein differentiating comprises converting the at least one integrated signal into a representation of the at least one encoded digital signal that is proportional to the rate of change of the at least one integrated signal.

2. A method according to claim 1 further comprising restoring the at least one encoded digital signal from the representation of the at least one encoded digital signal.

3. A method according to claim 2 further comprising AC coupling the representation of the at least one encoded digital signal before restoring the at least one encoded digital signal, wherein restoring the at least one encoded digital signal comprises comparing the representation of the at least one encoded digital signal to at least one reference digital signal and thereafter setting the representation of the at least one encoded digital signal relative to the at least one reference digital signal.

4. A method according to claim 1, wherein integrating the at least one encoded digital signal comprises low pass filtering the at least one encoded digital signal.

5. A method according to claim 1, wherein differentiating the at least one integrated signal comprises high pass filtering the at least one integrated signal.

6. A method according to claim 1 further comprising:
encoding at least one digital signal according to a predefined communications standard before integrating the at least one encoded digital signal; and
decoding the representation of the at least one encoded digital signal to thereby obtain a representation of the at least one digital signal, wherein decoding occurs after differentiating the at least one integrated signal.

7. A method according to claim 6, wherein encoding comprises encoding the at least one digital signal according to a predefined communications standard having zero content at a DC voltage level.

8. A method according to claim 7, wherein encoding comprises encoding the at least one digital signal according to a predefined communications standard selected from a group consisting of Manchester encoding, 4B5B encoding, 5B6B encoding and 8B10B encoding.

9. A method according to claim 6, wherein decoding the representation of the at least one encoded digital signal comprises decoding the representation of the at least one encoded digital signal according to the predefined communications standard.

10. A digital communications transmitter comprising:
an encoder capable of encoding at least one digital signal according to a predefined communications standard;
an integrator capable of integrating the at least one encoded digital signal, wherein said integrator is capable of converting the at least one encoded digital signal into an at least one integrated signal that is proportional to the time integral of the at least one encoded digital signal; and
a transmitter element capable of transmitting the at least one integrated signal.

11. A digital communications transmitter according to claim 10, wherein said encoder is capable of encoding the at least one digital signal according to a predefined communications standard that has zero content at a DC voltage level.

12. A digital communications transmitter according to claim 11, wherein the predefined communications standard is selected from a group consisting of Manchester encoding, 4B5B encoding, 5B6B encoding and 8B10B encoding.

13. A digital communications transmitter according to claim 10, wherein said integrator is an RC integrator comprising a low pass filter having at least one resistor and at least one capacitor.

14. A digital communications receiver comprising:
a receiver element capable of receiving at least one integrated signal, wherein the at least one integrated signal is proportional to the time integral of at least one encoded digital signal;
a differentiator capable of converting the at least one integrated signal into a representation of the at least one encoded digital signal that is proportional to the rate of change of the at least one integrated signal; and
a decoder capable of decoding the representation of the at least one encoded digital signal according to a predefined communications standard to thereby obtain a representation of at least one digital signal.

15. A digital communications receiver according to claim 14 further comprising a comparator capable of restoring the at least one encoded digital signal from the representation of the at least one encoded digital signal, wherein said comparator is capable of restoring the at least one encoded digital signal by comparing the representation of the at least one encoded digital signal to at least one reference digital signal and thereafter setting the representation of the at least one encoded digital signal relative to the at least one reference digital signal.

16. A digital communications receiver according to claim 15 further comprising a coupler capable of AC coupling the representation of the at least one encoded digital signal before said comparator restores the at least one encoded digital signal.

17. A digital communications receiver according to claim 14, wherein said decoder is capable of decoding the representation of the at least one encoded digital signal according to a predefined communications standard that has zero content at a DC voltage level.

18. A digital communications system according to claim 17, wherein the predefined communications standard is selected from a group consisting of Manchester encoding, 4B5B encoding, 5B6B encoding and 8B10B encoding.

19. A digital communications system according to claim 14, wherein said differentiator comprises an RC differentiator comprising a high pass filter having at least one resistor and at least one capacitor.

20. A digital communications system comprising:
a transmitter capable of integrating at least one encoded digital signal, wherein said transmitter is capable of integrating the at least one encoded digital signal by converting the at least one encoded digital signal into an at least one integrated signal that is proportional to the time integral of the at least one encoded digital signal, and wherein said transmitter is capable of transmitting the at least one integrated signal; and
a receiver capable of receiving the at least one integrated signal and thereafter differentiating the at least one integrated signal into a representation of the at least one encoded digital signal that is proportional to the rate of change of the at least one integrated signal.

21. A digital communications system according to claim 20, wherein said transmitter is further capable of encoding at least one digital signal according to a predefined communications standard to obtain the at least one encoded digital signal, and wherein said receiver is further capable of decoding the representation of the at least one encoded digital signal according to the predefined communications standard to obtain a representation of at least one digital signal.

22. A digital communications system according to claim 20, wherein said receiver is further capable of restoring the at least one encoded digital signal from the representation of the at least one encoded digital signal.

23. A digital communications system according to claim 22, wherein said receiver is further capable of restoring the at least one encoded digital signal by comparing the representation of the at least one encoded digital signal to at least one reference digital signal and thereafter setting the representation of the at least one encoded digital signal relative to the at least one reference digital signal.

24. A digital communications system according to claim 23, wherein said receiver is capable of AC coupling the representation of the at least one encoded digital signal before restoring the at least one encoded digital signal.
